(19) United States
(12) Patent Application Publication
(10) Pub. No.: US 2026/0104749 A1
(43) Pub. Date: Apr. 16, 2026

(54) Power Management Apparatus, Device, Method and Computer Program

(71) Applicant: Intel Corporation, Santa Clara, CA (US)

(72) Inventors: Sreeja MENON, Delhi (IN); Marcus WINSTON, Aloha, OR (US); Pawan CHHABRA, Bangalore (IN); Joaquin ROMERA, San Diego, CA (US); Marian CRETU, Santa Clara, CA (US); Vinod INIPODU MURUGAN, Bangalore (IN); Sean DARDIS, Forest Grove, OR (US); Ingrid MURPHY, San Jose, CA (US); Kamraan NASIM, Folsom, CA (US); Daniel APPERLOO, Delta (CA); Miraben PATEL, Folsom, CA (US); Pratap PRASAD, Santa Clara, CA (US); Biju Neerthattil SUDHAKARAN, Bangalore (IN)

(21) Appl. No.: 19/409,851

(22) Filed: Dec. 5, 2025

(51) Int. Cl. G06F 1/26

(52) U.S. Cl. CPC G06F 1/26

(57) ABSTRACT

Some aspects of the present disclosure relate to a power management apparatus for a memory subsystem of a graphics processing unit, the power management apparatus comprising first interface circuitry for communicating with a system firmware of a host computer hosting the graphics processing unit, second interface circuitry for communicating with one or more components of the memory subsystem of the graphics processing unit, processor circuitry configured to obtain a memory subsystem control input from the system firmware, trigger execution of a sequence of operations in response to the memory subsystem control input, and provide a memory subsystem control output to the system firmware based on a result of the sequence of operations.

### BACKGROUND

The memory sub system unit (MSU) of a graphics processing unit (GPU) consists of complex control and handshake flows as part of cold boot/warm boot/functional level reset (FLR)/power state/dynamic frequency scaling (DFS) flows, including clocking units, memory controllers, PHYs (Physical layer circuitry), DRAMs (Dynamic Random Access Memory) and their various handshake protocols.

In some systems, the task of configuring and controlling the memory subsystem unit (MSU) of a graphics processing unit (GPU) is handled by system firmware (FW), and all the nuances of MSU blocks are exposed to the system FW. As a result, architecture definition, design development, change loops, validation and debugs are time-consuming and potentially error-prone. Before system FW is complete, validation can happen only with lean functional models due to the long simulation times involved. Additionally, third-party IP (Intellectual Property) blocks are often involved, making the flows complex to solidify, with multiple changes being required. Once operational, the system FW may have to read multiple registers in MSU blocks to acquire consolidated MSU status.

### BRIEF DESCRIPTION OF THE FIGURES

Some examples of apparatuses and/or methods will be described in the following by way of example only, and with reference to the accompanying figures, in which:

FIG. 1a shows a block diagram of a power management apparatus or power management device for a memory subsystem of a graphics processing unit, of a graphics processing unit comprising the power management apparatus and the memory subsystem, and of a computer system comprising the graphics processing unit and a system firmware;

FIG. 1b shows a flowchart of a power management method for a memory subsystem of a graphics processing unit;

FIG. 2 shows a schematic drawing of a Memory Sub-System with a Power Management Agent;

FIG. 3 shows a table of memory subsystem hardware interfaces;

FIG. 4 shows a schematic diagram of the Memory PMA logic;

FIG. 5 shows a schematic diagram of a match logic;

FIG. 6 shows a flow chart of an example of the sequencer engine logic;

FIG. 7 shows a table of examples of firmware interfaces enabled by PMA;

FIG. 8 shows a flowchart of a PMA work point logic; and

FIG. 9 shows a block diagram of an example computer system or computing device.

### DETAILED DESCRIPTION

Some examples are now described in more detail with reference to the enclosed figures. However, other possible examples are not limited to the features of these embodiments that are described in detail. Other examples may include modifications of the features, as well as equivalents and alternatives to the features. Furthermore, the terminology used herein to describe certain examples should not be restrictive of further possible examples.

Throughout the description of the figures, the same or similar reference numerals refer to the same or similar elements and/or features, which may be identical or implemented in a modified form while providing the same or a similar function. The thickness of lines, layers, and/or areas in the figures may also be exaggerated for clarification.

When two elements A and B are combined using an “or”, this is to be understood as disclosing all possible combinations, i.e., only A, only B, as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the element so described must be in a given sequence, either temporally or spatially, in ranking, or any other manner. “Connected” may indicate elements are in direct physical or electrical contact with each other, and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably, and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

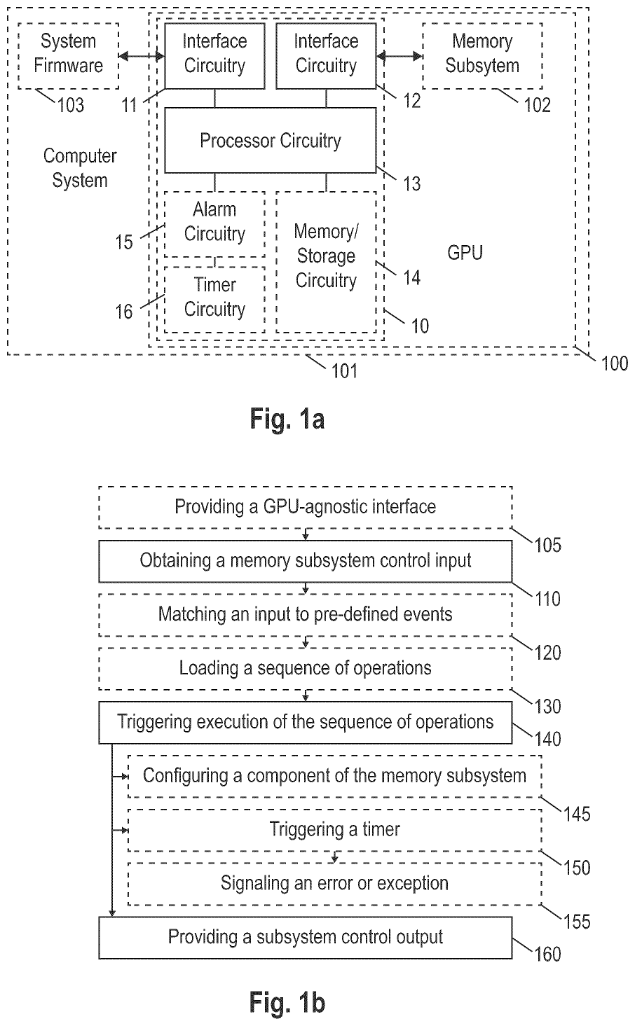

FIG. 1a shows a block diagram of a power management apparatus 10, or power management device 10, for a memory subsystem 102 of a graphics processing unit 101. FIG. 1a further shows a graphics processing unit 101 comprising the power management apparatus 10 and the memory subsystem 102. FIG. 1a further shows a computer system 100 comprising the graphics processing unit 101 and a system firmware 103.

The power management apparatus 10 comprises circuitry to provide the functionality of the power management apparatus 10. For example, the circuitry of the power management apparatus 10 may be configured to provide the functionality of the power management apparatus 10. For example, the power management apparatus 10 of FIG. 1a comprises first interface circuitry 11 for communicating with the system firmware 103 of the host computer 100 hosting the graphics processing unit 101, second interface circuitry 12 for communicating with one or more components of the memory subsystem of the graphics processing unit (e.g., for communicating with one or more memory controllers, one or more memory banks, one or more Physical layer components (PHYs), etc.), processor circuitry 13, (optional) memory/storage circuitry 14, optional alarm circuitry 15 and optional timer circuitry 16. For example, the processor circuitry 13 may be coupled with the first and second interface circuitry 11, 12, with the memory/storage circuitry 14, with the alarm circuitry 15 and/or with the timer circuitry 16. For example, the processor circuitry 13 may provide the functionality of the power management apparatus, in conjunction with the first and second interface circuitry 11, 12 (for communicating with the system firmware 103 and the components of the memory subsystem 102, respectively), the memory/storage circuitry 14 (for storing information, such as machine-readable instructions defining an operation of the power management apparatus), the alarm circuitry 15 (for triggering an exception or an interrupt) and/or the timer circuitry 16 (for detecting a timeout). Likewise, the power management device 10 may comprise means for providing the functionality of the power management device 10. For example, the means may be configured to provide the functionality of the power management device 10. The components of the power management device 10 are defined as component means, which may correspond to, or be implemented by, the respective structural components of the power management apparatus 10. For example, the power management device 10 of FIG. 1a comprises means for processing 13, which may correspond to or be implemented by the processor circuitry 13, a first and a second interface 11, 12, which may correspond to or be implemented by the first and second interface circuitry 11, 12, (optional) means for storing information 14, which may correspond to or be implemented by the memory or storage circuitry 14, an optical alarm giver 15, which may be implemented by the alarm circuitry 15, and a timer 16, which may be implemented by the timer circuitry 16. In general, the functionality of the processor circuitry 13 or means for processing 13 may be implemented by the processor circuitry 13 or means for processing 13 executing machine-readable instructions. Accordingly, any feature ascribed to the processor circuitry 13 or means for processing 13 may be defined by one or more instructions of a plurality of machine-readable instructions. The power management apparatus 10 or power management device 10 may comprise the machine-readable instructions, e.g., within the memory or storage circuitry 14 or means for storing information 14. In particular, the system firmware 104 may be configured to configure the power management apparatus 10 or power management device 10 by storing the machine-readable instructions in the power management apparatus 10 or power management device 10, e.g., in the memory or storage circuitry 14 or means for storing information 14. For example, the power management apparatus 10 may comprise non-volatile memory or read-only memory and volatile memory. It may store some instructions in the non-volatile memory/read-only memory, which are available at any time. At runtime, the security engine of the system firmware may store machine-readable instructions in the volatile memory, which may supersede the machine-readable instructions stored in the non-volatile memory or read-only memory.

The processor circuitry 13 or means for processing 13 is to obtain a memory subsystem control input from the system firmware 103. The processor circuitry 13 or means for processing 13 is to trigger execution of a sequence of operations in response to the memory subsystem control input. The processor circuitry 13 is to provide a memory subsystem control output to the system firmware based on the result of the sequence of operations (e.g., by storing the memory subsystem control output in a status register of the power management apparatus 10 or power management device 10 or the system firmware 103).

FIG. 1b shows a flowchart of a corresponding power management method for a memory subsystem of a graphics processing unit. For example, the power management method may be performed by the graphics processing unit 101, e.g., the memory subsystem 102 of the graphics processing unit 101, and in particular by the power management apparatus 10 or power management device 10 of FIG. 1a. The method comprises obtaining 110, the memory subsystem control input from the system firmware 103 of the host computer 100 hosting the graphics processing unit. The method comprises triggering execution 140 of the sequence of operations in response to the memory subsystem control input. The method comprises providing 160, the memory subsystem control output to the system firmware 103 based on the result of the sequence of operations (e.g., by storing the memory subsystem control output in a status register).

In the following, the features of the power management apparatus 10, the power management device 10 of the power management method of FIG. 1b, and of a corresponding computer program are discussed with reference to the power management apparatus 10 and the power management method. Features discussed in connection with the power management apparatus 10 or the power management method may likewise be included in the corresponding power management device 10 and the computer program.

Various examples of the present disclosure are based on the finding that power management for memory subsystems of graphics processing units is sometimes caught in a dependency loop—if the power management of the memory subsystem is not yet supported by the (system) firmware, it cannot be tested and validated. Therefore, in many cases, it is necessary to wait until the memory subsystem is supported before validation can be started, which can be detrimental to the time required for overall validation. The proposed concept helps in avoiding such scenarios by providing an intermediate layer (or “shim layer”) that allows for faster definition, development, creation, testing, debugging, and producing the memory subsystem. As another benefit, this approach also enables the use of different types of memory (e.g., GDDR (Graphics Double Data Rate), LPDDR (Low-Power Double Data Rate), HBM (High Bandwidth Memory)) without having to explicitly support this in the system firmware. Instead, the functionality can be implemented by the power management apparatus (also denoted Power Management Agent, PMA, or Memory Power Management Agent, MemPMA in the following) or power management method. In effect, the power management apparatus or power management method provides a GPU-agnostic interface, i.e., an interface that is not preconditioned on the system firmware being compatible with a specific GPU or specific type of memory subsystem or protocol, but an interface that can be used across different GPUs, memory subsystems or protocols. In other words, the processor circuitry may be configured to provide a GPU-agnostic, memory subsystem-agnostic or memory protocol-agnostic interface for handling memory subsystem control inputs. Accordingly, the power management method may comprise providing 105, a GPU-agnostic, memory subsystem-agnostic or memory protocol-agnostic interface for handling memory subsystem control inputs.

In contrast to other contexts, the proposed concept relates to complex flows, such as memory bring-up, frequency scaling, cold boot, warm boot, etc., which requires one or more operations to be completed, in sequence or as a group or any combination thereof (herein denoted “sequence of operations”). To facilitate such complex operations, the proposed concept may be implemented using programmable circuitry (in contrast to fixed-function circuitry such as static finite state machines that are used in other implementations), which causes the operation(s) to be performed. Thus, the processor circuitry may be programmable or configurable circuitry. Accordingly, the power management method may be at least partially performed by programmable or configurable circuitry.

In the present context, the term “trigger/triggering the sequence of operations” is used to indicate that the processor circuitry (i.e., the programmable circuitry) caused the operations to be performed. In many cases, this sequence of operations comprises operations to be performed by the processor circuitry and operations to be performed by a component of the memory subsystem (e.g., by a memory controller or by a PHY of the memory subsystem). In other words, during execution of the sequence of operations, the processor circuitry 13 may be configured to configure one or more of a PHY, a controller, or any memory subsystem component to perform an operation of the sequence of operations. Accordingly, the power management method may comprise configuring 145 one or more of a PHY, a controller, or a memory subsystem component while executing 140 the sequence of operations. In any case, if an operation is being performed by a component of the memory subsystem, it is triggered by the programmable circuitry of the power management apparatus or by the power management method.

The respective flows are initiated when the power management apparatus or power management method obtains the memory subsystem control input from the system firmware 103, or from any other component of the memory subsystem. This memory subsystem control input may be obtained via different types of interfaces or modes of communication. For example, the memory subsystem control input may be obtained via a sideband, such as a general-purpose sideband (GPSB) or a power-management sideband (PMSB), by signals (wires), or by any other means. Accordingly, the first interface circuitry 11 may be configured to communicate with the system firmware via a sideband interface, such as at least one of the GPSB or PMSB. Similarly, with respect to the power management method, communication with the system firmware may occur via any sideband interface. In some cases, other types of interfaces or calls may be used, such as individual or grouped signals (wires), p-code calls (processor code calls) or diagnostic tool calls.

In the proposed concept, the memory subsystem control input triggers a sequence of operations, comprised of one or more operations. For example, to support a wide range of control operations, the memory subsystem control input may relate to one of a memory subsystem boot operation (e.g., trigger the memory subsystem boot operation or a part thereof), a memory subsystem power management operation (e.g., trigger the memory subsystem power management operation (e.g., power state entry or frequency switching) or a part thereof), a resource management operation (e.g., trigger the memory subsystem to perform resource management), a status data retrieval operation (e.g., retrieve status data from the memory subsystem), a thermal data retrieval operation (e.g., retrieve thermal data from the memory subsystem), an error data retrieval operation (e.g., retrieve error data from the memory subsystem), an error handling or recovery operation (e.g., trigger handling of an error or performing a recovery in the memory subsystem), a reset operation (e.g., trigger a reset of the memory subsystem), or a fuse pulling operation (e.g., trigger a fuse pull in the memory subsystem).

To perform the sequence of events that matches the memory subsystem control input, the memory subsystem control input may be matched to the sequences of operations supported by the power management apparatus or power management method. For example, the processor circuitry 13 may include event matching circuitry (also denoted “match engine” in the following) configured to match an input received via the first interface circuitry to one of a plurality of pre-defined events, and to load the sequence of operations based on an output of the event matching circuitry. Accordingly, the power management method may comprise matching 120 the input received via the first interface to one of a plurality of pre-defined events, and loading 130 the sequence of operations based on the matching 120. This matching may be performed in a methodical manner. For example, the memory subsystem control input may be or comprise a multi-bit bit vector, with the different bits of the bit vector having specific meanings. For example, each bit of the bit vector (or most bits, in case there are reserved bits or deprecated bits) may be associated with a field (such as source identifier, type of operation (as operation code, or opcode), tag, payload, header data, etc.). Similarly, in case wires (i.e., single-bit interfaces) are used as control input, each wire (or a combination of multiple wires) may be associated with a field of the control input. Thus, the memory subsystem control input may comprise a plurality of fields, each of which may be matched. The matching may use a look-up table to match between the content of the fields of memory subsystem control input and the sequence of operations to be loaded (and thus to be performed). In other words, the event matching circuitry may be configured to match at least one of a source identifier of the input, an operation code of the input, a tag associated with the input, header data of the input, or payload data of the input to one of a plurality of pre-defined events. Accordingly, the act of matching 120 may comprise matching at least one of a source identifier of the input, an operation code of the input, a tag associated with the input, header data of the input, or payload data of the input to one of a plurality of pre-defined events. For example, the look-up table may specify that, for a given source identifier and op-code, a specific sequence of operations is to be performed. For example, if a memory subsystem control input with source identifier 5 and op-code 0x28 is obtained, the sequence of operations with index 1 may be loaded and triggered, etc. Similarly, in case wires are used as control input, the processor circuitry may be configured to match static levels (0 or 1) of the respective wires or rising or falling edges to one of a plurality of pre-defined events defined with respect to the levels, falling edges or rising edges of these wires. As is evident, in many cases, not all fields may be relevant for a given match. In the above example, the fields “tag”, “header data” and “payload” may be irrelevant for the match. To address cases where certain fields are irrelevant, the event matching circuitry may be configured to mask at least one of the plurality of fields when matching at least one of the predefined events. Once the matching has been performed, the respective sequence of operations to be performed may be loaded from memory. In other words, the processor circuitry may be configured to load the sequence of operations from memory circuitry 14 based on the memory subsystem control input. Accordingly, the power management method may comprise loading 130 the sequence of operations from memory 14 based on the memory subsystem control input.

Once loaded, the processor circuitry 13 triggers execution of the sequence of operations in response to the memory subsystem control input. In general, this is done by controlling/requesting the components of the memory subsystem 102 (e.g., PHY, memory controllers, or other components) to perform the operations. To control these components (or to perform certain operations directly), various means of communication or control may be used. For example, the processor circuitry 13 may perform at least one of registering a bus transaction on at least one bus of the memory subsystem of the graphics processing unit, performing a sideband transaction, asserting or deasserting one or more signals, or issuing a fuse puller instruction (and similar means/methods of communication or control). Accordingly, with respect to the power management method, executing 140, the sequence of operations may comprise at least one of registering a bus transaction on at least one bus of the memory subsystem of the graphics processing unit, performing a sideband transaction, asserting or deasserting one or more signals, or issuing a fuse puller instruction.

While the operations triggered by the power management apparatus or power management method may work in most cases, they may also occasionally fail, e.g., due to timing mismatches between components, components being stuck in an inoperational state, etc. To catch such cases, the power management apparatus or power management method may use timer(s) to detect cases in which the respective components do not provide the expected response (e.g., acknowledgement, result, etc.) within a pre-defined time interval. For example, the power management apparatus may comprise timer circuitry 16 (which may be part of the processor circuitry 13 or separate thereof) that is triggered to start incrementing or decrementing a timeout value when execution of a sequence is started. Accordingly, the power management method may comprise triggering a 150 timer to start incrementing or decrementing a timeout value when execution of a sequence is started. If the timer reaches a pre-defined target value (e.g., an expiration value) before the expected response is received, the power management apparatus/method and/or the system firmware may be alerted (e.g., so a recovery/reset procedure can be initiated). For example, when the timer reaches a pre-defined target value (and the expected response has not been received), circuitry (e.g., the alert circuitry 15 or the processor circuitry 13) may be configured to signal an error or exception (e.g., to the system firmware). Accordingly, the power management method may comprise signaling 155 an error or exception when the timer reaches a pre-defined target value.

There are also other scenarios in which the power management apparatus can perform error management. For example, the processor circuitry may be configured to aggregate errors across multiple components of the memory subsystem (e.g., four memory controllers or 2 PHYs). If the processor circuitry receives a response from only a subset of the components (e.g., from one memory controllers and not from the three other memory controllers) or the expected response does not match across multiple components, the processor circuitry may also report this as error to the system firmware.

After the sequence of operations is finished, the power management apparatus provides a memory subsystem control output (e.g., by storing the memory subsystem control output in a status register of the power management apparatus 10 or power management device 10 or the system firmware 103). At this point, the power management apparatus or power management method may provide an additional benefit by aggregating the individual control outputs of multiple components (e.g., one or more PHYs, one or more memory controllers) into a single memory subsystem control output that can be consumed by the system firmware.

The first interface circuitry 11/first interface 11 and/or the second interface circuitry 12/second interface 12 correspond to one or more inputs and/or outputs designed to receive and/or transmit information. This information can be in digital (bit) values according to a specified code, whether exchanged within a module, between different modules, or even between modules of distinct entities. For example, the first interface circuitry 11/first interface 11 and/or the second interface circuitry 12/second interface 12 may include interface circuitry configured to handle the reception and/or transmission of such information.

For example, the processor circuitry 13 or means for processing 13 can be implemented using one or more processing units, processing devices, or any means for processing, such as a processor, a computer, or a programmable hardware component equipped with appropriately adapted software. Thus, the described function of the processor circuitry 13 or means for processing 13 can be executed in software, running on one or more programmable hardware components. Such components may include a general-purpose processor, a Digital Signal Processor (DSP), a microcontroller, and more. For example, the processor circuitry 13 or means for processing 13 may be a sequencer or other type of programmable or configurable circuitry.

In at least one embodiment, the memory or storage circuitry 14 or means for storing information 14 may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the alarm circuitry 15 or alarm may be part of the processor circuitry 13/means for processing 13, or may be separate from the processor circuitry 13/means for processing 13. For example, the alarm circuitry 13 may be circuitry configured to process the output of a timer circuitry 16 or timer 16, and to raise an exception or interrupt based on the processed output.

For example, the timer circuitry 16 or timer 16 may be a purpose-built timer circuit configured to periodically increment or decrement a value and provide an output if the value reaches a threshold (e.g., 0). Alternatively, the timer circuitry 16 or timer 16 may be part of the processor circuitry 13 or means for processing 13.

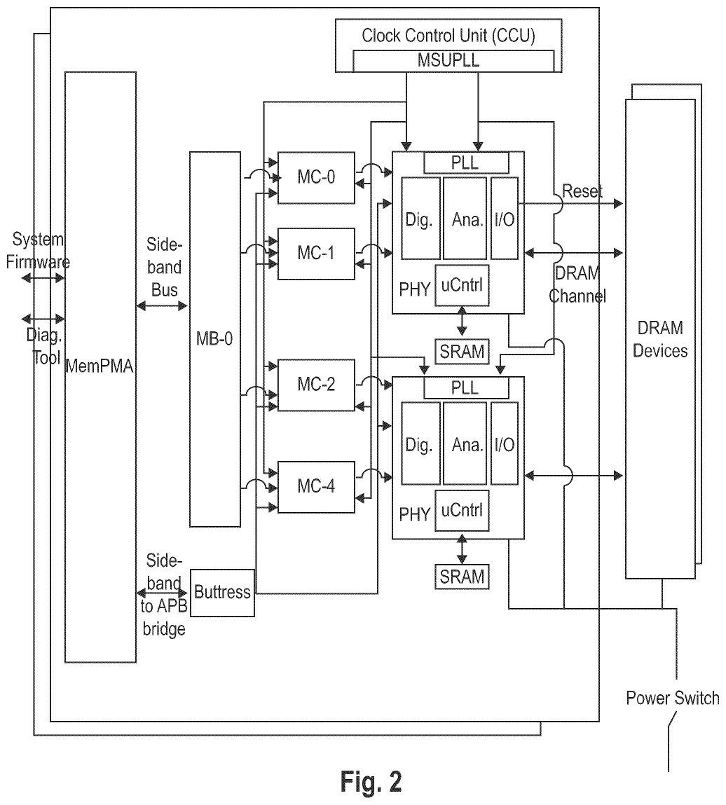

More details and aspects of the power management apparatus 10, power management device 10, power management method, the corresponding computer program, the graphics processing unit 101, or the computer system 100 are mentioned in connection with the proposed concept or one or more examples described above or below (e.g., FIGS. 2 to 9). The power management apparatus 10, power management device 10, power management method, the corresponding computer program, the graphics processing unit 101, or the computer system 100 may comprise one or more additional optional features corresponding to one or more aspects of the proposed concept or one or more examples described above or below.

Various examples of the present disclosure provide a memory power management agent. The proposed MSU (Memory Subsystem Unit, e.g., the memory subsystem 102 of FIG. 1a) power management agent (PMA), which may correspond to the power management apparatus 10 or power management device 10 of FIG. 1a and/or implements the power management method of FIG. 1b, addresses MSU configuration complexities by providing a small, programmable unit containing registers and executing code (e.g., by a sequencer) to control the entire memory subsystem independently. The PMA acts as an intermediary “shim layer” that encapsulates protocol-specific details. The PMA may be capable of handling all global MSU flows on its own, allowing MSU flows to be offloaded from system firmware. For example, the PMA may take responsibility for MSU configuration and enable independent operation. The PMA may enable complete architectural definition, development, validation, bring-up and debugging of the MSU without requiring the firmware to be complete. The firmware can manage the MSU at a very high level, with the PMA handling the operational details. For example, the proposed concept may be implemented by a (nano-) sequencer circuit within the memory subsystem and a firmware that uses common interfaces across different types of memory.

A memory subsystem for a GPU SoC (System on Chip) includes a memory power management agent (PMA) that automates the memory system configuration, enabling power management sequencing to be offloaded from the SoC firmware (i.e., the system firmware of the host computer system). The PMA may enable ‘push button operation’ of the MSU by the SoC firmware, operating independently of the SoC firmware. The SoC firmware can request the PMA to perform high-level operations, and the PMA may perform those operations without requiring the SoC firmware to have knowledge of the underlying sequences of registers and signals used to perform those operations. The PMA may allow changing the underlying memory subsystem details, such that no or minimal changes are required in the SoC firmware for GPUs with different memory subsystems (e.g., GDDR (Graphics Double Data Rate), LPDDR (Low-Power Double Data Rate), HBM (High Bandwidth Memory)). During bring-up, the PMA can facilitate validation of the MSU without requiring the SoC firmware to be complete. The PMA also allows autonomous management of the MSU in limited circumstances without requiring the intervention of the SoC firmware.

The proposed PMA may provide a protocol-agnostic interface. The firmware may interact with the PMA using generic “work points” or “sequence requests” (e.g., one or more of cold boot, warm boot, training, retraining, memory test, memory scrub, dynamic voltage/frequency switching, power state entry/exit, clock gating, etc.). The firmware does not need to know how these operations are performed at the protocol level. The proposed PMA may enable independent architectural definition, development, validation, bring-up and debugging, as these tasks can be performed without requiring fully functional firmware. The proposed concept may improve extensibility, as it is designed to be reusable across different memory protocols with minimal firmware changes. The proposed PMA may further provide programmability, as the user processor circuitry (e.g., the sequencer) is configurable, allowing for flexible control sequences (not hardwired like an FSM, Finite State Machine). Sequences may be defined by architects, engineers, debuggers and the like and converted into binary code loaded into the PMA. The PMA may further enable consolidated status reporting. For example, the PMA may aggregate status information from multiple memory controllers, presenting a simplified view to the firmware. This is particularly valuable in systems with many controllers/subsystems. The PMA may handle complex operations, managing not just resets but also handshakes, clocking (PLL (Phase-Locked Loop) programming), and other maintenance tasks, such as memory testing.

FIG. 2 shows a schematic drawing of a Memory Sub-System with a Power Management Agent (MemPMA). FIG. 2 shows a memory subsystem for a GPU SoC that includes a memory power management agent (MemPMA) that automates the memory system configuration. The MemPMA includes programmable circuitry, such as an independent sequencer, which handles (all of) the cold boot/warm boot/FLR (Function-Level Reset)/power state/DFS (Dynamic Frequency Scaling) flows of MSU, offloading the system firmware from the nuances of controlling the various MSU blocks, which include PLLs, PHYs, controllers, and thereby DRAMs. The firmware initially loads configuration data (including system firmware lookup tables) into the PMA, and then no longer needs to directly manage individual controller interactions. For a given frequency set point, the PMA configures the various PLLs, Memory Bridges (MB), Memory Controllers (MC) and PHYs for the memory system to enable it to operate at the selected frequency.

The sequencer handshakes with system firmware through sideband (SB) workpoints and through input wires/signals (System Firmware, Diagnostic Tool) and Look Up Table programming, after which the MSU PMA independently handles offload of functional operations, freeing the system firmware to do other critical tasks in parallel. The MSU PMA may consolidate status from multiple blocks in MSU (Example, PHYs and MCs, and logs consolidated status, reducing the register reads from system firmware).

The sequencer may be extendable to handle more tasks such as device temperature read out, throttling based on temperature/bandwidth, support for RAS (Reliability, Availability, and Serviceability) features, error interrupts, and more. MSU architectural definition, development, validation, bring-up and debugging may happen independently, accelerating design sign-off.

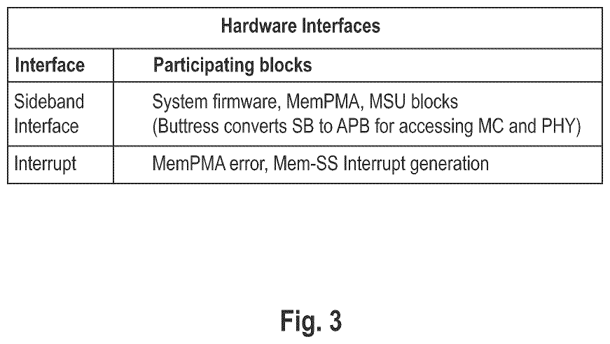

In various examples, the memory sub-system may include the hardware interfaces shown below in FIG. 3. FIG. 3 shows a table of memory subsystem hardware interfaces. For example, these interfaces may include a sideband interface, such as the PMSB (Power Management Sideband) or the GPSB (General Purpose Sideband), with MemPMA, system firmware and MSU being the affected blocks, and an Interrupt interface (with MemPMA being used for error detection, and MSU being used for Interrupt generation). For example, the respective interfaces may be based on writing instructions/information into a control register.

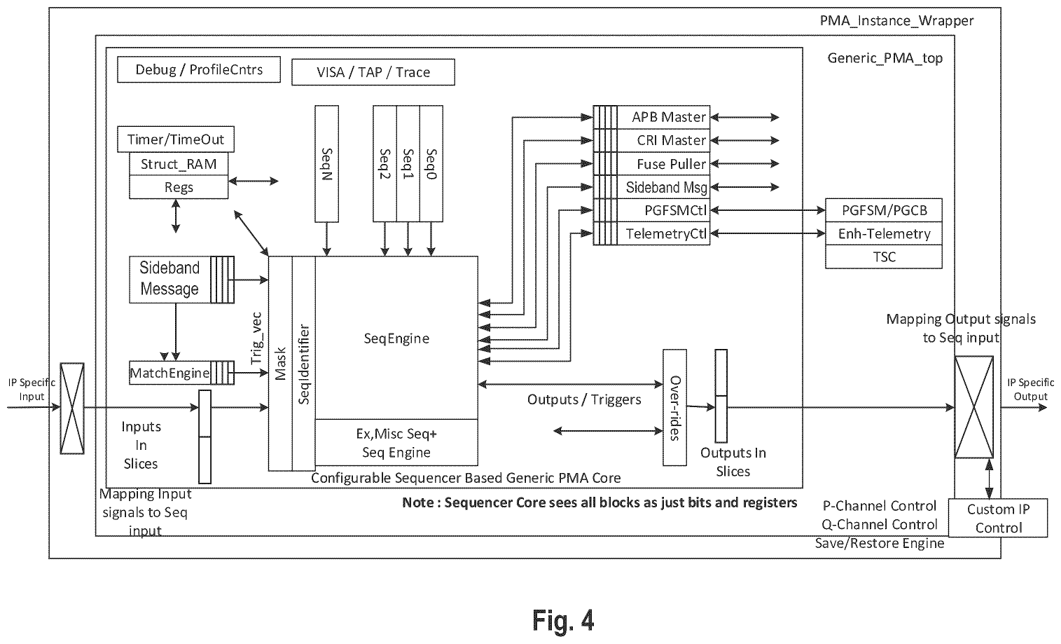

FIG. 4 shows a schematic diagram of the memory PMA Logic, which may include the programmable sequencer engine SeqEngine (or other type of programmable circuitry) that is configurable to perform pre-determined sequences of register writes and signal assertions to perform operations on the MSU. The Memory PMA Logic receives memory subsystem control input (MSU Ctr. Input), which may be sliced and processed according to mask and sequence identifier circuitry and using data received via sideband receive circuitry, such as general purpose side band (GPSB) and power management side band (PMSB) receive circuitry, as well as input signals, both individual and in combinations (vectors). The sequencer engine may replay pre-defined sequences to generate memory subsystem control output, which may perform memory subsystem boot, power management, and frequency scaling operations.

The memory PMA may include a sequencer engine, which may be a 32-bit programmable sequencer that provides an abstraction layer between system firmware and the underlying power management hardware, simplifying development and maintenance. The memory PMA operates based on “events” signals or messages received, e.g., via Sideband interfaces (such as GPSB & PMSB). These events trigger pre-defined sequences, which is how it responds to requests such as resets, power state transitions, and frequency changes. The Memory PMA may be capable of mastering register-bus transactions on the APB (AMBA Peripheral Bus) to different components in MSU. It may also master sideband transactions, Fuse puller instructions and more.

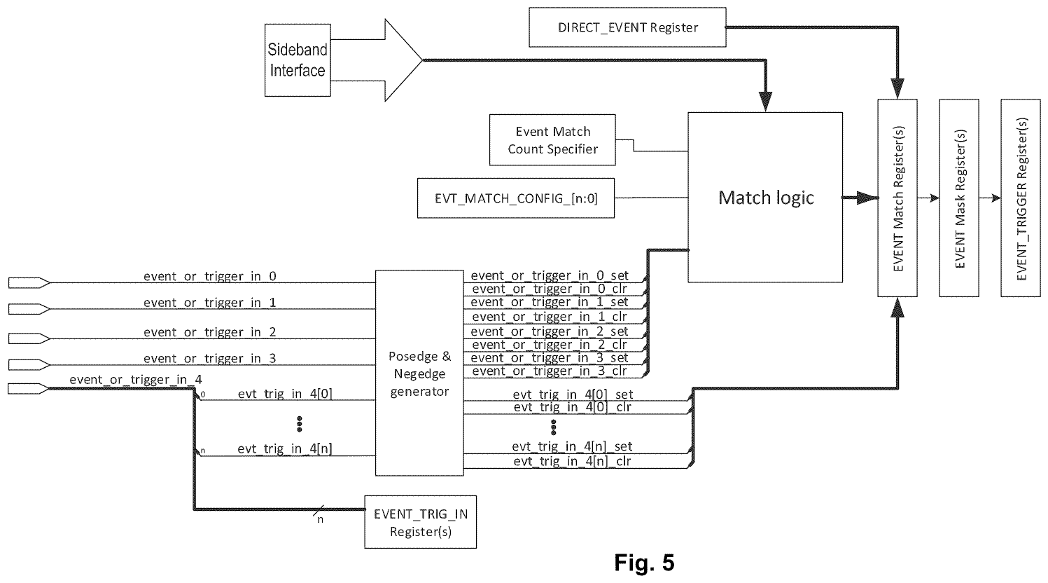

FIG. 5 shows a schematic diagram of the match logic. FIG. 5 shows the “Match Engine,” which identifies relevant events by analyzing incoming message fields. The Match Engine is a component of the Generic PMA responsible for identifying incoming messages and signals that should trigger specific sequences within the hardware.

The match engine may perform Event Classification. In particular, the Match Engine may classify various inputs as “events.” These events may include one or more of (a) reception of an IOSF-Sideband message (from a sideband interface, such as GPSB or PMSB), (b) direct event register write received from a sideband interface, such as PMSB, (c) rising edge or falling edge of an input signal, or (d) responses from other SB agents resulting from messages sent by the Generic PMA.

For example, the Match Engine's behavior may be configured via match configuration registers. These registers define what constitutes a matching event, including whether any of the defined fields are masked or unmasked. Multiple of these registers can be used to define several different events. Each register may hold criteria for matching specific fields within an incoming message.

For example, the Match Engine may perform Field Matching. For example, the Match Engine may support matching on one or more of the following message fields: (a) SourceIDX: The source identifier of the message, (b) Opcode: The operation code of the message, (c) Tag: A tag associated with the message, (d) Misc: Miscellaneous data within the message, or (e) Payload: The payload (data) portion of the message. Specific bytes within the payload can be matched, including fields related to register access transactions, completion, and reset preparation.

For example, the Match Engine may have Masking Capabilities, i.e., the ability to mask certain fields when determining a match. This allows flexibility in defining events: 8-bit or less fields may be maskable on a per-field basis (individual bits can be ignored). More than 8-bit fields may be maskable on a per-byte basis (groups of 8 bits can be ignored). If all mask bits for a field are set, that field may effectively be ignored during the matching process. This means any value in that field may result in a match.

With respect to Priority & Hit Detection, the Match Engine may prioritize incoming messages over input signals. When an incoming message arrives, it may be compared against all configured match configuration registers. If multiple registers match the incoming message (a “hit”), the corresponding bits in a status register are set.

A matching event (i.e., a hit) may trigger the execution of a pre-defined sequence within the sequencer, provided that the event is not masked and has the highest priority. In simpler terms: If the goal is to trigger a sequence when a message with opcode 0x28 arrives from source ID 5, a match configuration register may be configured, setting SourceIDX to 5, Opcode to 0x28, and masking all other fields. Any message arriving with those specific values may be considered a match and trigger the associated sequence. The masking allows ignoring irrelevant parts of the message, making the matching process more flexible.

For example, the MemPMA may use Lookup Tables (corresponding to different frequency set points, which store pre-defined settings for different operating conditions.

Overall, the PMA may provide one or more of the following services: For example, the PMA may provide Reset Services: Control the reset signals of all the MSU blocks across Cold/Warm/FLR resets. For example, the PMA may provide Power State transition services: Power state transitions between Idle, Active and low-power states; dynamic voltage and frequency switching controls with MSU blocks For example, the PMA may provide Resource Management services, such as a) Ungating/Gating of the clocks, b) Unlocking/applying trims/locking of the PLL's, c) Ramping Agent IP-specific FIVR's (fully integrated voltage regulator), if any, d) PGFSM (Power Gating Finite State Machine) control, e) Trim controls - like for Memory Trims - related to DVFS (Dynamic Voltage and Frequency Scaling) operating point,, and/or g) PLL control - Control bring-up/down the PLL, and also change the frequency of the PLL. For example, the PMA may provide Fuses Services, such as a) Fuse pull for the Agent IP's that don't have fuse pull, and/or b) Subsequent forwarding of fuse values to a CSR (Control/Status register). For example, the PMA may provide other Agent IP-specific services, such as a) Trigger Save/Restore Engines, and/or b) Trigger P-Channel (a communication channel used for power management commands and control signals between the GPU and system)/Q-Channel (a communication channel typically used for quality of service (QoS) information or queue management in GPU architectures) control Engines.

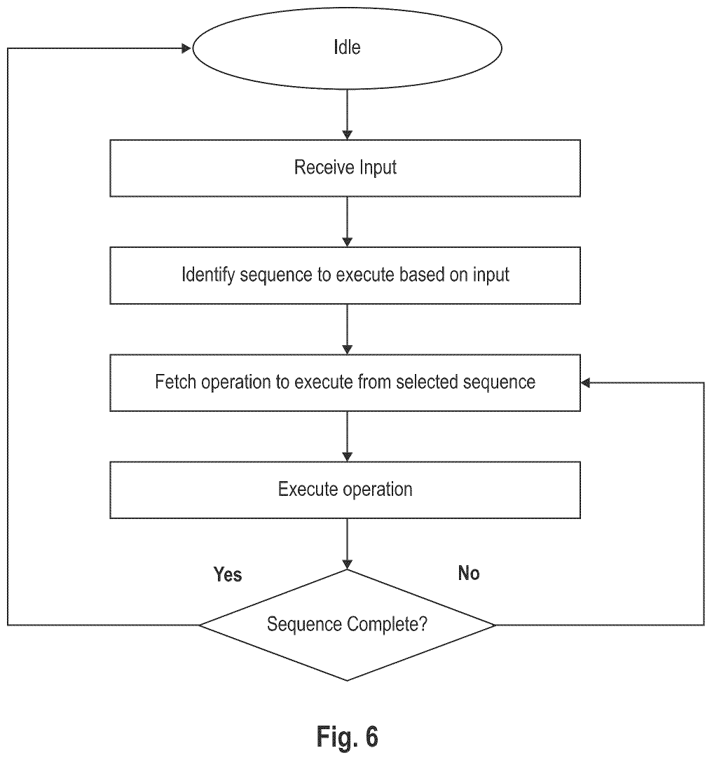

FIG. 6 shows a flow chart of an example of the sequencer engine logic. The sequencer engine may operate using the logic of FIG. 6. The sequencer engine may receive input in the form of memory subsystem control input. The input may be sliced and masked according to control input, and a sequence may be identified from a set of N pre-determined sequences via a sequence identifier based in part on sideband messages, such as general-purpose sideband (GPSB) and power-management sideband (PMSB) messages. Operations within a sequence may be fetched and executed by the sequencer engine. The sequencer engine may be a hardware sequencer engine, or a standard or non-standard microcontroller/microprocessor, such as a RISC processor with a small (e.g., 62-instruction) ISA (Instruction Set Architecture) that is tailored to provide a “hardware-like” solution rather than “firmware executing on a microcontroller”. The sequencer engine may couple with a timer/timeout circuitry that executes a watchdog timer that decrements during instruction execution. If the timer reaches zero, a machine check exception may be thrown. Otherwise, all sequences may execute atomically, with operations of a sequence fetched and executed in-order until the sequence is complete. When a sequence completes, the sequencer engine may return to an idle state until additional input is received.

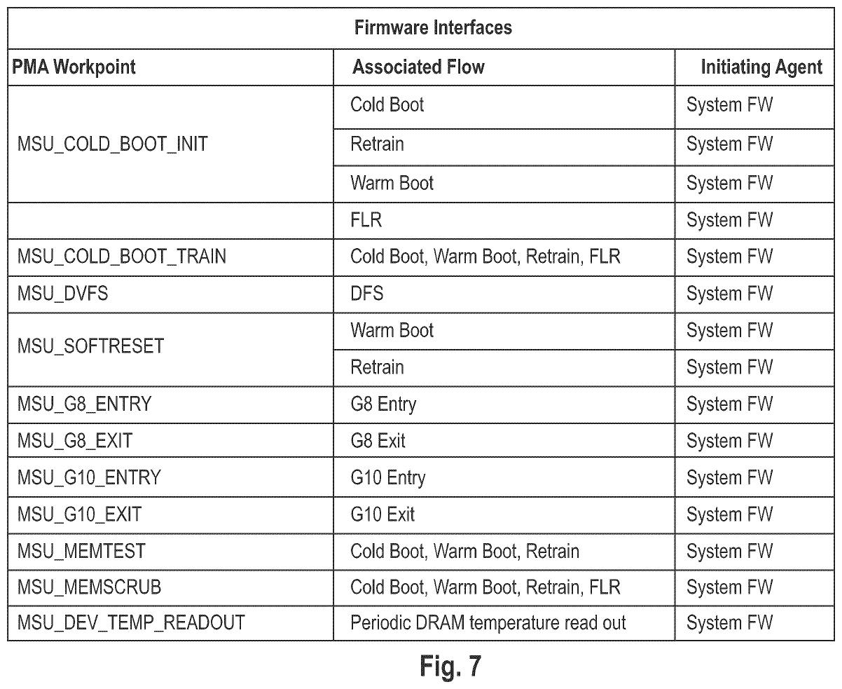

FIG. 7 shows a table of examples of firmware interfaces enabled by PMA. Multiple work points may be supported to interface with the system firmware. The PMA may enable the offload of system firmware from MSU-level complete protocol handshakes and other controls. The PMA allows a multi-tiered approach wherein MSU PMA performs Tier-1 tasks within the MSU, while the system firmware can perform other tasks. The PMA may then gather a consolidated status from multiple MSU components and write that status to consolidated registers that contain status from multiple subsystem components. The system firmware may then perform consolidated register reads as Tier-2 tasks, to read out the status.

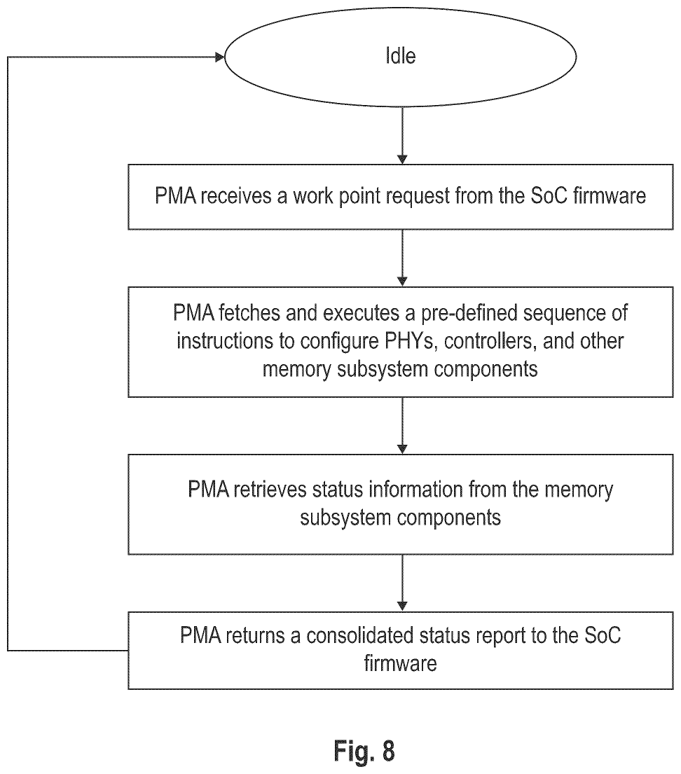

FIG. 8 shows a flowchart of the PMA work point logic. The SoC firmware may issue a request to the PMA, which may be received as a work point request. The PMA may fetch and execute a pre-defined sequence of instructions (the sequencer code). This sequence may control the PHYs, controllers, and other memory subsystem components. The PMA may return a consolidated status report to the firmware.

In the following, some examples of work point flows are provided.

For example, the PMA may support a vendor ID (identifier) read-out flow. In this use case the system maintains a DRAM vendor specific LUT (Look-Up Table) for targeted DRAM parameters. In this flow, the cold boot workpoint may be run in multiple phases. In first phase, system FW programs the MSU to operate in limited boot mode in order to perform vendor ID readout. Once vendor ID is read out, system FW performs checks against expect memory part and parameters and if required, reruns complete cold boot phases with memory part and parameters updated.

For example, the PMA may support a memory test flow. In particular, the memory controllers (MCs) may support a Memory Test Engine that can be configured to send various known patterns and check the health of the memory interface. The Memory Test Engine may be triggered by the system firmware immediately after completing the training. For example, a memory test may be run as part of every cold boot, which is the most robust way to validate link stability. In the memory test flow, the MemPMA may write into the MC registers to configure and start the test. The MemPMA may then poll for status from (all of) the MCs (and aggregate the results from the MCs into the (implementation-specific) PMA register. System firmware may thus read a single register in the Memory Subsystem (PMA register) to determine the status of the memory test operation. The control register setup in MC for memory test may be done by the System firmware as part of LUT loading (Example: Addressing format).

For example, the PMA may support a Memory Scrub flow. In the Memory Scrub flow, the MemPMA may write into (all of) the Memory Controller (MC) registers to configure, enable, and run the Memory Test. Memory wipe may be supported as an independent work point by MemPMA which can be used by system FW for boot flows, or FLR (Functional Level Reset) flow. The PMA may poll for the Memory Scrub status from all MCs, and aggregate the status into a single PMA register. System FW may thus read a single register in the Memory Subsystem (PMA register) to determine the status of the memory scrub. The control register setup in the MC for Memory Scrub may be performed by System firmware as part of LUT loading (Example: start/end addresses).

In some examples, the PMA may support bandwidth (BW) telemetry. In general, MCs support BW monitoring on a per-channel basis. The System firmware may pull the Read/Write BW counters periodically. The MC may support per-channel Read/Write/Command count. The PMA can gather aggregate BW counters and report a consolidated status. If bandwidth limits are approaching, it can handshake with the SoC firmware to increase frequency. In some circumstances, the PMA may be authorized to autonomously perform limited adjustments and optionally report adjustment status to the SoC firmware afterwards, or update a consolidated status register that can be read by the SoC firmware to indicate the adjustment. In some examples, the PMA may support error reporting. For example, the MemPMA may handle multiple error scenarios. The error status may be logged in Mem PMA registers. An Interrupt may be generated from MemPMA for an error scenario and passed to IEH (Integrated Error Handler) for error reporting. Examples of error reporting may include (1) Init complete not asserted from one of the PHYs, (2) PHY requested frequency change request to an FSP which is not a valid entry in FSP table, (3) Mem PMA received frequency change request from one PHY, but timed out for the other PHY, (4) Mem PMA received frequency change request to different frequencies on different PHYs, (5) Mem PMA received expected LP*ACK value from one PHY, but timed out on other PHY, and/or (6) Mem PMA register polling timed out on one or more of MSU registers.

More details and aspects of the memory power management agent are mentioned in connection with the proposed concept or one or more examples described above or below (e.g., FIG. 1a to 1b, 9). The memory power management agent may comprise one or more additional optional features, corresponding to one or more aspects of the proposed concept or one or more examples described above or below.

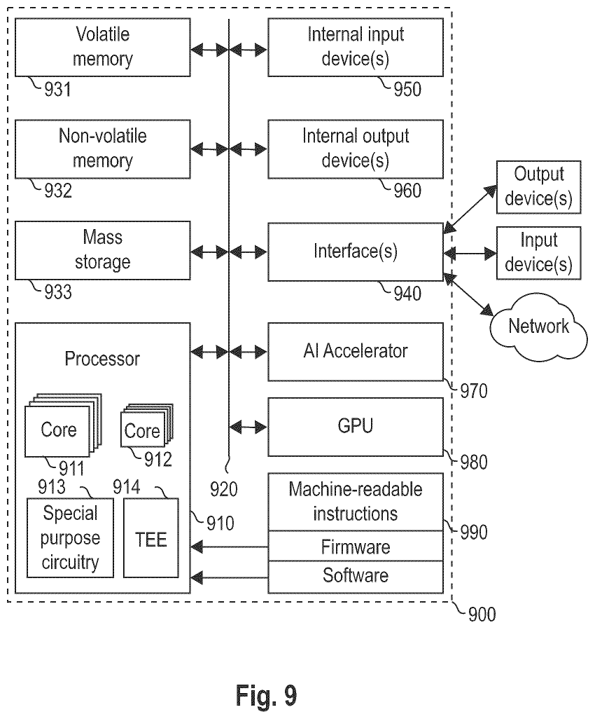

FIG. 9 shows a block diagram of an example computer system 900 or computing device 900 structured to execute and/or instantiate the machine-readable instructions and/or operations of FIGS. 1a to 8 to implement the power management apparatus, power management device or power management method. The computer system 900 or computing device 900 may be, for example, a server, a personal computer, a workstation, a self-learning machine (e.g., a neural network), a mobile device (e.g., a cell phone, a smartphone, a tablet such as an iPad™), a personal digital assistant (PDA), an Internet appliance, a DVD player, a CD player, a digital video recorder, a Blu-ray player, a gaming console, a personal video recorder, a set-top box, a headset (e.g., an augmented reality (AR) headset, a virtual reality (VR) headset, etc.) or other wearable device, or any other type of computing device.

The computer system 900 or computing device 900 of the illustrated example includes processor circuitry 910. The processor circuitry 910 of the illustrated example is hardware. For example, the processor circuitry 910 can be implemented by one or more integrated circuits, logic circuits, FPGAs (Field-Programmable Gate Array), microprocessors, CPUs (Central Processing Units), GPUs (Graphics Processing Units), DSPs (Digital Signal Processors), and/or microcontrollers from any desired family or manufacturer. The processor circuitry 910 may be implemented by one or more semiconductor-based (e.g., silicon-based) devices. For example, the processor circuitry 910 may provide the functionality of the computer system 900 or computing device 900.

The processor circuitry 910 comprises one or more processor cores 911, 912. For example, the processor circuitry 910 may have heterogeneous cores. Heterogeneous cores in CPUs refer to the use of different types of cores within a single processor, typically combining high-performance (BIG) cores with power-efficient (LITTLE) cores. Thus, the processor circuitry 910 may comprise one or more BIG cores 911 and one or more LITTLE cores 912. BIG cores are designed for performance-intensive tasks and provide higher processing power, but they consume more energy. LITTLE cores, on the other hand, are optimized for energy efficiency and handle less demanding tasks to prolong battery life and reduce power consumption.

The processor circuitry 910 of the illustrated example is in communication, e.g., via one or more bus interfaces 920, with a main memory including a volatile memory 931 and a non-volatile memory 932. The volatile memory 931 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 932 may be implemented by flash memory and/or any other desired type of memory device. Access to the main memory 931, 932 of the illustrated example is controlled by a memory controller, which may be implemented by special-purpose circuitry 913 of the processor circuitry 910.

The computer system 900 or computing device 900 of the illustrated example also includes one or more mass storage devices 933 to store software and/or data. Examples of such mass storage devices 933 include magnetic storage devices, optical storage devices, floppy disk drives, HDDs, CDs, Blu-ray disk drives, redundant array of independent disks (RAID) systems, solid state storage devices such as flash memory devices, and DVD drives.

The computer system 900 or computing device 900 of the illustrated example also includes interface circuitry 940. The interface circuitry 940 may be implemented by hardware in accordance with any type of interface standard, such as an Ethernet interface, a WiFi interface, a cellular modem, a universal serial bus (USB) interface, a Bluetooth® interface, a near field communication (NFC) interface, a PCI (Peripheral Component Interconnect) interface, and/or a PCIe (Peripheral Component Interconnect Express) interface. For example, the interface circuitry 940 of the illustrated example may include a communication device such as a transmitter, a receiver, a transceiver, a modem, a residential gateway, a wireless access point, and/or a network interface to facilitate exchange of data with external machines (e.g., computing devices of any kind) by a network. The communication can be by, for example, an Ethernet connection, a digital subscriber line (DSL) connection, a telephone line connection, a coaxial cable system, a satellite system, a line-of-site wireless system, a cellular telephone system, an optical connection, etc.

In the illustrated example, one or more internal input devices 950 and/or one or more external input devices are connected to the interface circuitry 940 or the bus 920. The input device(s) permit a user to enter data and/or commands into the processor circuitry 910. The input device(s) can be implemented by, for example, an audio sensor, a microphone, a camera (still or video), a keyboard, a button, a mouse, a touchscreen, a trackpad, a trackball, an isopoint device, and/or a voice recognition system.

One or more internal output devices 960 and/or one or more external output devices are also connected to the interface circuitry 940 of the illustrated example. The output devices 960 can be implemented, for example, by display devices (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, a printer, and/or speaker. The computer system 900 or computing device 900 of the illustrated example, thus, typically includes a graphics driver card, a graphics driver chip, and/or graphics processor circuitry such as a GPU 913, 980, which may correspond to or be part of the processor circuitry 910, for example as special purpose circuitry 913 or as cores 911, 912, or separate from the processor 910, for example as a separate GPU 980.

The computer system 900 or computing device 900 of the illustrated example may include an AI Accelerator 970. For example, the AI Accelerator 970 may be configured to improve the computational speed and efficiency of machine learning tasks by executing parallel processing operations tailored for neural network models. The AI Accelerator 970 may include hardware such as Graphics Processing Units (GPUs), Tensor Processing Units (TPUs), or other specialized processors designed to handle large volumes of data with low latency. For example, the Processor 910, the AI Accelerator 970, the integrated GPU 913, and/or the dedicated GPU 980 may be considered xPUs (x Processing Units, where x is a placeholder) of the computer system 700 or computing device 700.

The computer system 900 or computing device 900 of the illustrated example includes machine-readable instructions 990. For example, the machine-readable instructions may be part of firmware or software of the computer system 900 or computing device 900. The machine-readable instructions 990 may be stored in the mass storage device 933, in the volatile memory 931, in the non-volatile memory 932, and/or on a removable non-transitory computer-readable storage medium such as a CD or DVD.

In the following, some examples of the proposed concept are presented:

An example (e.g., example 1) relates to a power management apparatus (10) for a memory subsystem (102) of a graphics processing unit (101), the power management apparatus comprising first interface circuitry (11) for communicating with a system firmware (103) of a host computer (100) hosting the graphics processing unit, second interface circuitry (12) for communicating with one or more components of the memory subsystem of the graphics processing unit, processor circuitry (13) configured to obtain a memory subsystem control input from the system firmware, trigger execution of a sequence of operations in response to the memory subsystem control input, and provide a memory subsystem control output to the system firmware based on a result of the sequence of operations.

Another example (e.g., example 2) relates to a previous example (e.g., example 1) or to any other example, further comprising that the processor circuitry is configured to load the sequence of operations from memory circuitry based on the memory subsystem control input.

Another example (e.g., example 3) relates to a previous example (e.g., example 2) or to any other example, further comprising that the processor circuitry comprises event matching circuitry configured to match an input received via the first interface circuitry to one of a plurality of pre-defined events, and to load the sequence of operations based on an output of the event matching circuitry.

Another example (e.g., example 4) relates to a previous example (e.g., example 3) or to any other example, further comprising that the event matching circuitry is configured to match at least one of a source identifier of the input, an operation code of the input, a tag associated with the input, header data of the input, or payload data of the input to one of a plurality of pre-defined events.

Another example (e.g., example 5) relates to a previous example (e.g., one of the examples 3 or 4) or to any other example, further comprising that the input comprises a plurality of fields, wherein the event matching circuitry is configured to mask at least one of the plurality of fields when matching at least one of the predefined events.

Another example (e.g., example 6) relates to a previous example (e.g., one of the examples 1 to 5) or to any other example, further comprising that the memory subsystem control input relates to one of a memory subsystem boot operation, a memory subsystem power management operation, a resource management operation, a status data retrieval operation, a thermal data retrieval operation, an error data retrieval operation, an error handling or recovery operation, a reset operation, or a fuse pulling operation.

Another example (e.g., example 7) relates to a previous example (e.g., one of the examples 1 to 4) or to any other example, further comprising that the processor circuitry is configured to provide a graphics processing unit-agnostic-agnostic, memory subsystem-agnostic or memory protocol-agnostic interface for handling memory subsystem control inputs.

Another example (e.g., example 8) relates to a previous example (e.g., one of the examples 1 to 7) or to any other example, further comprising that the processor circuitry is a programmable or configurable circuitry.

Another example (e.g., example 9) relates to a previous example (e.g., one of the examples 1 to 8) or to any other example, further comprising that the first interface circuitry is configured to communicate with the system firmware via at a sideband interface.

Another example (e.g., example 10) relates to a previous example (e.g., one of the examples 1 to 9) or to any other example, further comprising that executing the sequence of operations comprises at least one of registering a bus transaction on at least one bus of a memory subsystem of the graphics processing unit, performing a sideband transaction, asserting or deasserting one or more signals, or issuing a fuse puller instruction.

Another example (e.g., example 11) relates to a previous example (e.g., one of the examples 1 to 10) or to any other example, further comprising that the processor circuitry is configured to configure one or more of a PHY, a controller, or a memory subsystem component while executing the sequence of operations.

Another example (e.g., example 12) relates to a previous example (e.g., one of the examples 1 to 11) or to any other example, further comprising that the power management apparatus comprises a timer circuitry that is triggered to start incrementing or decrementing a timeout value when execution of a sequence is started.

Another example (e.g., example 13) relates to a previous example (e.g., example 12) or to any other example, further comprising that the apparatus comprises circuitry configured to signal an error or exception when the timer reaches a pre-defined target value.

Another example (e.g., example 14) relates to a previous example (e.g., one of the examples 1 to 12) or to any other example, further comprising that the sequence of operations relates to a complex function, such as memory bring-up, etc.

Another example (e.g., example 15) relates to a graphics processing unit (101) comprising the power management apparatus (10) according to one of the examples 1 to 14.

Another example (e.g., example 16) relates to a computer system (100), comprising a system firmware (103) and the graphics processing unit (101) according to example 15.

An example (e.g., example 17) relates to a power management device (10) for a memory subsystem (102) of a graphics processing unit (101), the power management device comprising a first interface for communicating with a system firmware (103) of a host computer (100) hosting the graphics processing unit, a second interface for communicating with one or more components of the memory subsystem of the graphics processing unit, means for processing configured to obtain a memory subsystem control input from the system firmware, triggering execution of a sequence of operations in response to the memory subsystem control input, and provide a memory subsystem control output to the system firmware based on a result of the sequence of operations.

Another example (e.g., example 18) relates to a previous example (e.g., example 17) or to any other example, further comprising that the means for processing is configured to load the sequence of operations from memory circuitry based on the memory subsystem control input.

Another example (e.g., example 19) relates to a previous example (e.g., example 18) or to any other example, further comprising that the means for processing comprises event matching circuitry configured to match an input received via the first interface to one of a plurality of pre-defined events, and to load the sequence of operations based on an output of the event matching circuitry.

Another example (e.g., example 20) relates to a previous example (e.g., example 19) or to any other example, further comprising that the event matching circuitry is configured to match at least one of a source identifier of the input, an operation code of the input, a tag associated with the input, header data of the input, or payload data of the input to one of a plurality of pre-defined events.

Another example (e.g., example 21) relates to a previous example (e.g., one of the examples 19 or 20) or to any other example, further comprising that the input comprises a plurality of fields, wherein the event matching circuitry is configured to mask at least one of the plurality of fields when matching at least one of the predefined events.

Another example (e.g., example 22) relates to a previous example (e.g., one of the examples 17 to 21) or to any other example, further comprising that the memory subsystem control input relates to one of a memory subsystem boot operation, a memory subsystem power management operation, a resource management operation, a status data retrieval operation, a thermal data retrieval operation, an error data retrieval operation, an error handling or recovery operation, a reset operation, or a fuse pulling operation.

Another example (e.g., example 23) relates to a previous example (e.g., one of the examples 17 to 20) or to any other example, further comprising that the means for processing is configured to provide a graphics processing unit-agnostic-agnostic, memory subsystem-agnostic or memory protocol-agnostic interface for handling memory subsystem control inputs.

Another example (e.g., example 24) relates to a previous example (e.g., one of the examples 17 to 23) or to any other example, further comprising that the means for processing is a programmable or configurable circuitry.

Another example (e.g., example 25) relates to a previous example (e.g., one of the examples 17 to 24) or to any other example, further comprising that the first interface is configured to communicate with the system firmware via a sideband interface.

Another example (e.g., example 26) relates to a previous example (e.g., one of the examples 17 to 25) or to any other example, further comprising that executing the sequence of operations comprises at least one of registering a bus transaction on at least one bus of a memory subsystem of the graphics processing unit, performing a sideband transaction, asserting or deasserting one or more signals, or issuing a fuse puller instruction.

Another example (e.g., example 27) relates to a previous example (e.g., one of the examples 17 to 26) or to any other example, further comprising that the means for processing is configured to configure one or more of a PHY, a controller, or a memory subsystem component while executing the sequence of operations.

Another example (e.g., example 28) relates to a previous example (e.g., one of the examples 17 to 27) or to any other example, further comprising that the power management device comprises a timer that is triggered to start incrementing or decrementing a timeout value when execution of a sequence is started.

Another example (e.g., example 29) relates to a previous example (e.g., example 28) or to any other example, further comprising that the device comprises means configured to signal an error or exception when the timer reaches a pre-defined target value.

Another example (e.g., example 30) relates to a previous example (e.g., one of the examples 17 to 28) or to any other example, further comprising that the sequence of operations relates to a complex function, such as memory bring-up, etc.

Another example (e.g., example 31) relates to a graphics processing unit (101) comprising the power management device (10) according to one of the examples 17 to 30.

Another example (e.g., example 32) relates to a computer system (100), comprising a system firmware (103) and the graphics processing unit (101) according to example 31.

An example (e.g., example 33) relates to a power management method (10) for a memory subsystem (102) of a graphics processing unit (101), the power management method comprising obtaining (110) a memory subsystem control input from a system firmware (103) of a host computer (100) hosting the graphics processing unit, triggering execution (140) of a sequence of operations in response to the memory subsystem control input, and providing (160) a memory subsystem control output to the system firmware based on a result of the sequence of operations.

Another example (e.g., example 34) relates to a previous example (e.g., example 33) or to any other example, further comprising that the method comprises loading (130) the sequence of operations from memory circuitry based on the memory subsystem control input.

Another example (e.g., example 35) relates to a previous example (e.g., example 34) or to any other example, further comprising that the method comprises matching (120) an input received via the first interface to one of a plurality of pre-defined events, and loading (130) the sequence of operations based on the matching (120).

Another example (e.g., example 36) relates to a previous example (e.g., example 35) or to any other example, further comprising that the act of matching (120) comprises matching at least one of a source identifier of the input, an operation code of the input, a tag associated with the input, header data of the input, or payload data of the input to one of a plurality of pre-defined events.

Another example (e.g., example 37) relates to a previous example (e.g., one of the examples 35 or 36) or to any other example, further comprising that the input comprises a plurality of fields, wherein at least one of the plurality of fields is masked when matching at least one of the predefined events.

Another example (e.g., example 38) relates to a previous example (e.g., one of the examples 33 to 37) or to any other example, further comprising that the memory subsystem control input relates to one of a memory subsystem boot operation, a memory subsystem power management operation, a resource management operation, a status data retrieval operation, a thermal data retrieval operation, an error data retrieval operation, an error handling or recovery operation, a reset operation, or a fuse pulling operation.

Another example (e.g., example 39) relates to a previous example (e.g., one of the examples 33 to 36) or to any other example, further comprising that the method comprises providing (105) a graphics processing unit-agnostic-agnostic, memory subsystem-agnostic or memory protocol-agnostic interface for handling memory subsystem control inputs.

Another example (e.g., example 40) relates to a previous example (e.g., one of the examples 33 to 39) or to any other example, further comprising that the method is at least partially performed by a programmable or configurable circuitry.

Another example (e.g., example 41) relates to a previous example (e.g., one of the examples 33 to 40) or to any other example, further comprising that the communication with the system firmware is performed via a sideband interface.

Another example (e.g., example 42) relates to a previous example (e.g., one of the examples 33 to 41) or to any other example, further comprising that executing (140) the sequence of operations comprises at least one of registering a bus transaction on at least one bus of a memory subsystem of the graphics processing unit, performing a sideband transaction, asserting or deasserting one or more signals, or issuing a fuse puller instruction.

Another example (e.g., example 43) relates to a previous example (e.g., one of the examples 33 to 42) or to any other example, further comprising that the method comprises configuring (145) one or more of a PHY, a controller, or a memory subsystem component while executing (140) the sequence of operations.

Another example (e.g., example 44) relates to a previous example (e.g., one of the examples 33 to 43) or to any other example, further comprising that the power management method comprises triggering a (150) timer to start incrementing or decrementing a timeout value when execution of a sequence is started.

Another example (e.g., example 45) relates to a previous example (e.g., example 44) or to any other example, further comprising that the method comprises signaling (155) an error or exception when the timer reaches a pre-defined target value.

Another example (e.g., example 46) relates to a previous example (e.g., one of the examples 33 to 44) or to any other example, further comprising that the sequence of operations relates to a complex function, such as memory bring-up, etc.

Another example (e.g., example 47) relates to a graphics processing unit (101) configured to perform the power management method (10) according to one of the examples 33 to 46.

Another example (e.g., example 48) relates to a computer system (100), comprising a system firmware (103) and the graphics processing unit (101) according to example 47.

Another example (e.g., example 49) relates to a computer program having a program code for performing the method of one of the examples 33 to 46, when the computer program is executed on a computer, a processor, or a programmable hardware component.

Another example (e.g., example 50) relates to a non-transitory, computer-readable medium comprising a program code that, when the program code is executed on a processor, a computer, or a programmable hardware component, causes the processor, computer, or programmable hardware component to perform the method of one of the examples 33 to 46.

The aspects and features described in relation to a particular one of the previous examples may also be combined with one or more of the further examples to replace an identical or similar feature of that further example or to additionally introduce the features into the further example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A power management apparatus for a memory subsystem of a graphics processing unit, the power management apparatus comprising:
first interface circuitry for communicating with a system firmware of a host computer hosting the graphics processing unit;
second interface circuitry for communicating with one or more components of the memory subsystem of the graphics processing unit;
processor circuitry configured to:
obtain a memory subsystem control input from the system firmware,
trigger execution of a sequence of operations in response to the memory subsystem control input, and
provide a memory subsystem control output to the system firmware based on a result of the sequence of operations.

2. The power management apparatus according to claim 1, wherein the processor circuitry is configured to load the sequence of operations from memory circuitry based on the memory subsystem control input.

3. The power management apparatus according to claim 2, wherein the processor circuitry comprises event matching circuitry configured to match an input received via the first interface circuitry to one of a plurality of pre-defined events, and to load the sequence of operations based on an output of the event matching circuitry.

4. The power management apparatus according to claim 3, wherein the event matching circuitry is configured to match at least one of a source identifier of the input, an operation code of the input, a tag associated with the input, header data of the input, or payload data of the input to one of a plurality of pre-defined events.

5. The power management apparatus according to claim 3, wherein the input comprises a plurality of fields, wherein the event matching circuitry is configured to mask at least one of the plurality of fields when matching at least one of the predefined events.

6. The power management apparatus according to claim 1, wherein the memory subsystem control input relates to one of a memory subsystem boot operation, a memory subsystem power management operation, a resource management operation, a status data retrieval operation, a thermal data retrieval operation, an error data retrieval operation, an error handling or recovery operation, a reset operation, or a fuse pulling operation.

7. The power management apparatus according to claim 1, wherein the processor circuitry is configured to provide a graphics processing unit-agnostic-agnostic, memory subsystem-agnostic or memory protocol-agnostic interface for handling memory subsystem control inputs.

8. The power management apparatus according to claim 1, wherein the processor circuitry is a programmable or configurable circuitry.

9. The power management apparatus according to claim 1, wherein the first interface circuitry is configured to communicate with the system firmware via at a sideband interface.

10. The power management apparatus according to claim 1, wherein executing the sequence of operations comprises at least one of registering a bus transaction on at least one bus of a memory subsystem of the graphics processing unit, performing a sideband transaction, asserting or deasserting one or more signals, or issuing a fuse puller instruction.

11. The power management apparatus according to claim 1, wherein the processor circuitry is configured to configure one or more of a PHY, a controller, or a memory subsystem component while executing the sequence of operations.

12. The power management apparatus according to claim 1, wherein the power management apparatus comprises a timer circuitry that is triggered to start incrementing or decrementing a timeout value when execution of a sequence is started.

13. The apparatus according to claim 12, wherein the apparatus comprises circuitry configured to signal an error or exception when the timer reaches a pre-defined target value.

14. The power management apparatus according to claim 1, wherein the sequence of operations relates to a complex function, such as memory bring-up, etc.

15. A graphics processing unit comprising the power management apparatus according to claim 1.

16. A computer system, comprising a system firmware and the graphics processing unit according to claim 15.

17. A power management method for a memory subsystem of a graphics processing unit, the power management method comprising:
obtaining a memory subsystem control input from a system firmware of a host computer hosting the graphics processing unit,
triggering execution of a sequence of operations in response to the memory subsystem control input, and
providing a memory subsystem control output to the system firmware based on a result of the sequence of operations.

18. The power management method according to claim 17, wherein the method comprises loading the sequence of operations from memory circuitry based on the memory subsystem control input.

19. The power management method according to claim 18, wherein the method comprises matching an input received via the first interface to one of a plurality of pre-defined events, and loading the sequence of operations based on the matching.

20. A non-transitory, computer-readable medium comprising a program code that, when the program code is executed on a processor, a computer, or a programmable hardware component, causes the processor, computer, or programmable hardware component to perform the method of claim 17.
